(19) United States
(12) Patent Application Publication
(10) Pub. No.: US 2017/0161380 A1
(43) Pub. Date: Jun. 8, 2017

(54) SERVER AND MUSIC SERVICE PROVIDING SYSTEM AND METHOD

(71) Applicant: Chiun Mai Communication Systems, Inc., New Taipei (TW)

(72) Inventors: CHIH-PU HSU, New Taipei (TW); HSIU-HUA YEN, New Taipei (TW); SUNG-JAY CHANG, New Taipei (TW)

(21) Appl. No.: 15/252,627

(22) Filed: Aug. 31, 2016

(30) Foreign Application Priority Data
Dec. 4, 2015 (CN) 201510878550.8

(51) Int. Cl. G06F 17/30

(52) U.S. Cl. CPC G06F 17/30772; G06F 17/30755; H04L 65/4069

(57) ABSTRACT

A method for providing music service includes generating a music playlist. The music playlist is sent to a terminal device. At least one group of dynamic parameters is received from the terminal device. The music playlist is adjusted according to the least one group of dynamic parameters when the dynamic parameters is received. Once an adjusted music playlist is obtained, the adjusted music playlist is sent to the terminal device.

### CROSS-REFERENCE TO RELATED APPLICATIONS

This application claims priority to Chinese Patent Application No. 201510878550.8 filed on Dec. 4, 2015, the contents of which are incorporated by reference herein. This application is related to a commonly-assigned application entitled, “ELECTRONIC DEVICE AND MUSIC PLAY SYSTEM AND METHOD”, filed ______ (Atty. Docket No. US58943).

### FIELD

The subject matter herein generally relates to data processing technology, and particularly to a server and a music service providing system and method.

### BACKGROUND

Servers are used to process information. For example, the server can be used to provide a user with music service.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of a server and a terminal device.

FIG. 2 is a block diagram of one embodiment of modules of a music service providing system installed in the server of FIG. 1.

FIG. 3 illustrates an example of a first setting interface for setting state parameters.

FIG. 4 illustrates an example of a second setting interface for setting preference parameters.

FIG. 5 illustrates an example of a further setting interface for setting the preference parameters.

FIG. 6 illustrates an example of a prompt interface for prompting related information.

FIG. 7 illustrates a flow chart of one embodiment of a method for providing music service.

FIG. 8 illustrates a flow chart of one embodiment of a method for sharing the related information.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

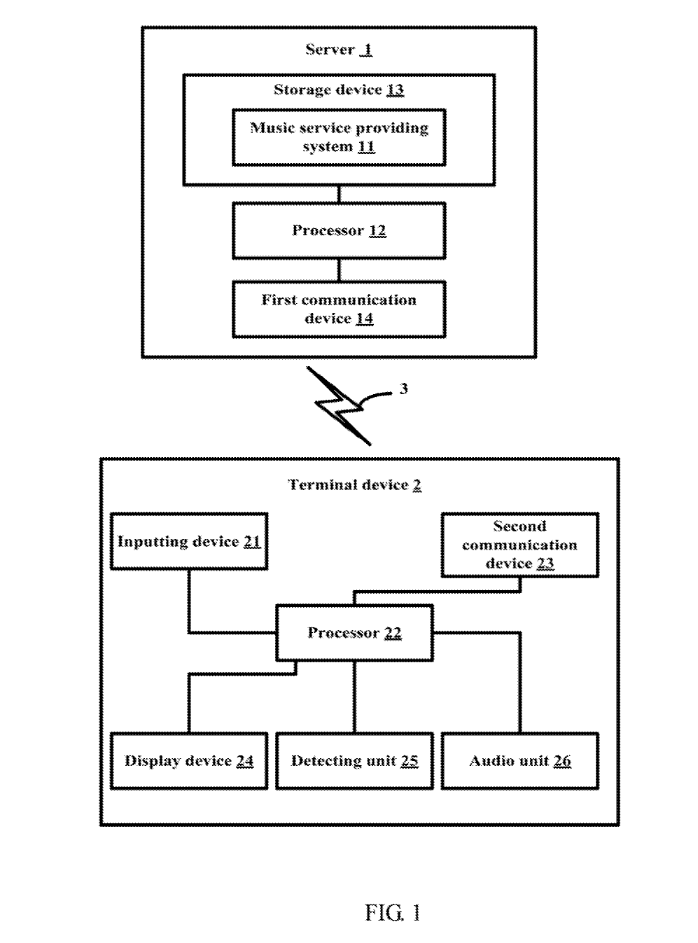

FIG. 1 is a block diagram of one embodiment of a server and a terminal device. Depending on the embodiment, a server 1 can communicate with one or more terminal device 2 through a network 3. The server 1 may include, but is not limited to, at least one processor 12, a storage device 13, and a first communication device 14. The at least one processor 12, the storage device 13, and the first communication device 14 are connected to each other. The at least one processor 12 can be used to calculate and processing various kinds of data of the server 1. The storage device 13 can be used to store the various kinds of data. In at least one embodiment, a music service providing system 11 is stored in the storage device 13, and is executed by the at least one processor 12. The music service providing system 11 can communicate with the one or more terminal device 2 via the network 3 using the first communication device 14.

In at least one embodiment, the storage device 13 can pre-store account information of the terminal device 2 logging into the server 1. In at least one embodiment, the account information includes a plurality of account numbers and a password corresponding to each of the plurality of account numbers. The storage device 13 can further store a plurality of audio files and/or video files in various kinds of formats. The storage device 13 can further pre-store a plurality of music playlists, and/or related information between each of the plurality of audio files. In at least one embodiment, each of the plurality of music playlists corresponds to more than one audio files. The more than one audio files can be stored in the server 1 or in the terminal device 2. In at least one embodiment, when the music playlist includes an audio file that is stored in the terminal device 2, the audio file that is stored in the terminal device 2 takes priority to be played. In other embodiments, when the music playlist includes the audio file that is stored in the terminal device 2, an order of playing the more than one audio files is adjusted according to the audio file that is stored in the terminal device 2. In at least one embodiment, the related information of each of the plurality of audio files can include, but is not limited to, a singer's name, an album's name, a style, an emotion, a mood, a rhythm, and a suitable state correspond to each of the plurality of audio files. In at least one embodiment, the style can be a rock style, a metal style, a light style, a smooth style, a crystal style, or a classic style. The emotion can be joy, sorrow, vent, or relaxed. The mood can be a mood in travel, disappointed in love, a mood in sweet, a mood in lonely, a mood in stunned, or a mood in hot dance. The rhythm can be slow, medium, or fast. The suitable state can be a state in working, a state in exercising, a state in gathering, or a state right before sleep. In at least one embodiment, the state in exercising can include, but is not limited to, a static state, a walking state, a running state, a bicycling state, and a driving state. In at least one embodiment, each of the plurality of audio files can correspond to one or more styles, one or more emotions, one or more moods, and one or more suitable states. The said style, emotion, mood, and the rhythm can be adjusted according to user's requirement.

In at least one embodiment, the server 1 can communicate with the at least one terminal device 2 through the network 3 by using the first communication device 14, to receive requests from the terminal device 2 or send data to the terminal device 2.

In at least one embodiment, the terminal device 2 can include, but is not limited to, an inputting device 21, a processor 22, a second communication device 23, a display device 24, a detecting unit 25, and an audio unit 26. The inputting device 21 can be a touch screen, a keyboard, or a sound recognition device. The terminal device 2 can input data such as characters, pictures, hand gestures, voice using the inputting device 21. The terminal device 2 can process all the data of the terminal device 2 using the processor 22. The terminal device 2 can communicate with the server 1 using the second communication device 23. In at least one embodiment, the first communication device 14 and the second communication device 23 can be wireless communication devices, such as 2G wireless communication devices, 3G wireless communication devices, or 4G wireless communication devices, for example.

The display device 24 can be used to display the data of the terminal device 2. For example, the display device 24 can display the data obtained from the server 1.

The detecting unit 25 can include a plurality of detecting devices (not indicated in FIG. 1). The plurality of detecting devices can be internally or externally configured in the terminal device 2. For example, the plurality of detecting devices can be wirelessly or wired connected with the terminal device 2. In at least one embodiment, the plurality of the detecting devices can include, but are not limited to, a positioning device, a speed detecting device, and/or a sensing device. The positioning device can be used to detect a position of the terminal device 2. The speed detecting device can be used to detect a movement speed value of the terminal device 2. The sensing device can be used to detect physiological parameters of a user of the terminal device 2. For example, the physiological parameters can be a heart rate, a blood pressure value, a number of walk steps, a sleep state, consumed calories, a body temperature value, and a mood of the user.

In at least one embodiment, the positioning device can be a global position system (GPS) device. The terminal device 2 can receive GPS signals of at least three satellites using the GPS device of the detecting unit 25. The terminal device 2 can further process the GPS signals to obtain time of transmitting and a difference of carrier phase. The terminal device 2 can obtain a current position, a current movement speed value, and current time of the terminal device 2 by processing the time of transmitting and the difference of carrier phase. The sensing device can be a three-axis acceleration sensor. The terminal device 2 can calculate the number of walk steps of the user of the terminal device 2 using the three-axis acceleration sensor of the detecting unit 25. The terminal device 2 can further calculate the consumed calories of the user using the number of walk steps, an age, a weight value, and a moving distance value, and a movement speed value of the user. The sensing device can be a heartbeat detecting sensor. The terminal device 2 can calculate a heartbeat frequency of the user using the heartbeat detecting sensor of the detecting unit 25. The sensing device can be a blood pressure detecting sensor. The terminal device 2 can calculate a blood pressure value of the user using the blood pressure detecting sensor of the detecting unit 25. The terminal device 2 can further record the heartbeat frequency and the blood pressure value. In other embodiments, the detecting unit 25 can include any suitable detecting device that can be used to detect the position, the movement speed value of the terminal device 2, and the physiological parameters of the user of the terminal device 2.

The audio unit 26 can be used to play audio files stored in the terminal device 2 or play audio files received from the server 1.

In at least one embodiment, the terminal device 2 can be a mobile terminal, a mobile phone, a smart phone, a personal digital assistant (PDA), a laptop, a tablet personal computer, a digital camera, or a smart wearable device (e.g., a smart watch, a smart band, smart clothes, smart shoes, smart glove, or any other suitable electronic device).

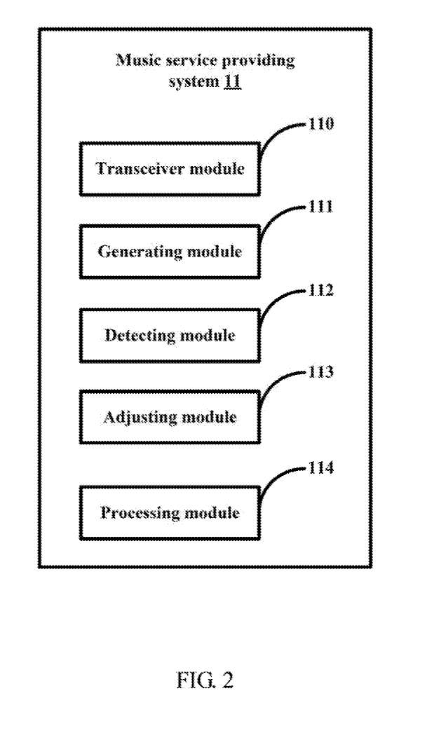

In at least one embodiment, as illustrated in FIG. 2, the music service providing system 11 can be installed in the server 1. The music service providing system 11 can include a transceiver module 110, a generating module 111, a detecting module 112, an adjusting module 113, and a processing module 114. In at least one embodiment, the modules 110-114 can include computerized codes in form of one or more programs, which are stored in the storage device 13, and are executed by the at least one processor 12. In other embodiments, the modules 110-114 can be hardware or firmware.

In at least one embodiment, when the terminal device 2 is connected with the server 1, the transceiver module 110 can receive a group of state parameters and/or at least one group of preference parameters from the terminal device 2. In other embodiments, the transceiver module 110 can receive multiple groups of state parameters from the terminal device 2. In at least one embodiment, the terminal device 2 can log into the server 1 by sending the account information to the server 1. In other embodiments, the terminal device 2 can log into the server 1 directly, i.e., the terminal device 2 is no need to send the account information to the server 1.

In at least one embodiment, when the terminal device 2 is connected with the server 1, the transceiver module 110 can send a first setting interface for setting/selecting state parameters and/or a second setting interface for setting/selecting preference parameters to the terminal device 2. The transceiver module 110 can further display the first setting interface and the second interface on the display device 24 of the terminal device 2. The transceiver module 110 can receive the state parameters selected from the first setting interface by the terminal device 2, and/or receive the preference parameters selected from the second setting interface by the terminal device 2. In at least one embodiment, when the terminal device 2 successfully logs into the server 1 by sending an account and a password corresponding to the account to the server 1, the transceiver module 110 can create a list to record a relationship between the account number and the received state parameters and/or the received preference parameters. The transceiver module 110 can further store the list into the storage device 13. In at least one embodiments, the transceiver module 110 can further automatically obtain data of listened song from the server 1. For example, the obtained data may include a style, a singer name, and a mood of the listened song.

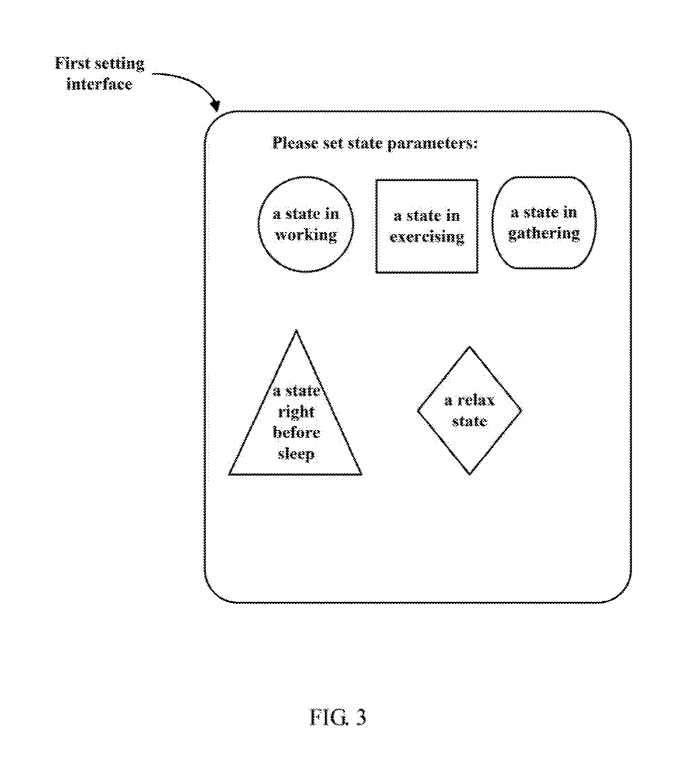

FIG. 3 illustrates the first setting interface for setting/selecting the state parameters. In at least one embodiment, the first setting interface can provide the user with multiple groups of different state parameters for selecting. For example, the multiple groups of different state parameters include a state in working, a state in exercising, a state in gathering, a state right before sleep, and a relax state. Each of the multiple groups of different state parameters can be displayed using an icon. Each icon may have a same or a different shape and color. The user can select one group of state parameters from the multiple groups of different state parameters using the inputting device 21 of the terminal device 2, according to a current state of the user. It should be noted that types of the different state parameters, a number of the multiple groups of different state parameters, and the arrangement mode of the multiple groups of different state parameters are not limited as illustrated in FIG. 3.

In other embodiments, the multiple groups of different state parameters can be distinguished in more detail. For example, the multiple groups of different state parameters can include time parameters, position parameters and action parameters. The time parameters can include, but is not limited to, work time, after work time, holiday time, relaxing time, and exercising time. The position parameters can include, but is not limited to, at home, at the office, at sporting place, at gathering place, and at relaxing place. The action parameters can include, but is not limited to, a static state, a walking state, a running state, a bicycling state, and a driving state. Accordingly, the related information of each of the plurality of audio files can further include the said one or more state parameters.

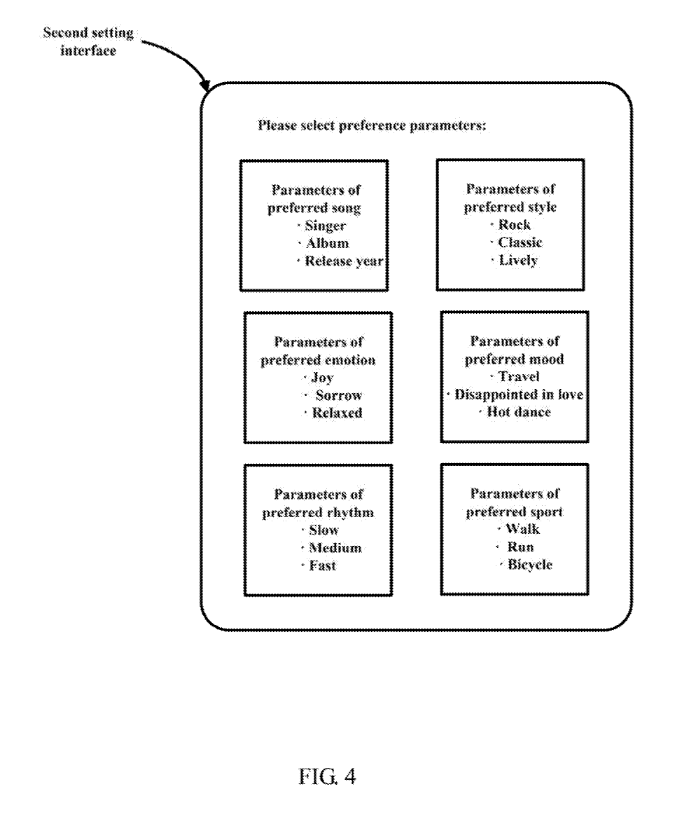

FIG. 4 illustrates the second setting interface for setting the preference parameters. In at least one embodiment, the second setting interface can provide the user with multiple groups of preference parameters for selecting. In at least one embodiment, the multiple groups of preference parameters can include, but are not limited to, parameters of preferred song, parameters of preferred style, parameters of preferred emotion, parameters of preferred mood, parameters of preferred rhythm, parameters of preferred sport, or a combination of the parameters of preferred song, the parameters of preferred style, the parameters of preferred emotion, the parameters of preferred mood, the parameters of preferred rhythm, and the parameters of preferred sport. Each of the preference parameters can include a plurality of options for the terminal device 2 to choose. The user of the terminal device 2 can select at least one group of preference parameters by choosing one or more options of each of the preference parameters. For example, the user of the terminal device 2 can select a first group of preference parameters by choosing the “medium” option from the “parameters of preferred rhythm”. The user can select a second group of preference parameters by choosing one or more singers' names under the “singer” option of the “parameters of preferred song”. The user can further select a third group of preference parameters by choosing the “rock” option from the “parameters of preferred style”. The terminal device 2 can determine an audio file meeting a current state and preference of the user according to the three groups of preference parameters selected by the user.

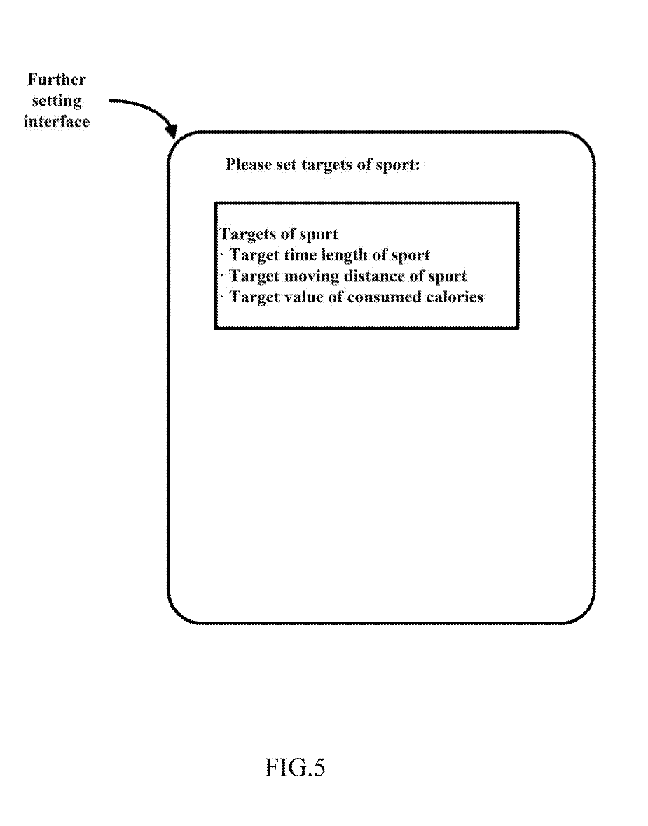

In at least one embodiment, when the user chooses one option from the “parameters of preferred sport” as illustrated in FIG. 4, the transceiver module 110 can display a further setting interface for setting one or more targets of sport on the display device 24 of the terminal device 2 as illustrated in FIG. 5, to prompt the user to set one or more targets of sport. In at least one embodiment, the one or more targets of sport can include, but are not limited to, target time length of sport, a target moving distance of sport, and target value of consumed calories during the sport. The user can set the one or more targets of sport according to personal requirements. It should be noted that a classification of the preference parameters, a number of the preference parameters, and an arrangement mode of the preference parameters are not limited as illustrated in FIG. 4 and FIG. 5.

In other embodiments, the terminal device 2 can detect various data using the detecting unit 25. For example, the various data can include, but are not limited to, speed information (e.g., a static state, a walking state, a running state, a bicycling state, or a driving state), position information, time information and/or a combination of the speed information, the position information, and time information. The terminal device 2 can determine a current state of the terminal device 2 by processing the detected data according to logical operations. The terminal device 2 can further determine state parameters of the terminal device 2 according to the current state of the terminal device 2. The terminal device 2 can further send the state parameters of the terminal device 2 to the server 1. For example, the terminal device 2 can determine the terminal device 2 is currently at a gymnasium or at a stadium according to position information detected by a first detecting device such as a GPS device of the detecting unit 25. The terminal device 2 can determine the terminal device 2 is moving with a speed value according to data detected by a second detecting device such as a three-axis acceleration sensor of the detecting unit 25. The terminal device 2 can further determine the “state in exercising” is the current state of terminal device 2, according to the data detected by the first detecting device and the second detecting device. The terminal device 2 can determine the “state in exercising” is the state parameters of the terminal device 2. For another example, when the terminal device 2 is determined to be in a working state, according to first data detected by the detecting unit 25, the first data includes the terminal device 2 is at a office and a movement speed value of the terminal device 2 is less than a predetermined value. The terminal device 2 determines that the “state in working” is the state parameters of the terminal device 2. For another example, when the terminal device 2 determines that the terminal device 2 is in a static state according to second data detected by the detecting unit 25, the second data includes the movement speed value of the terminal device 2 is 0 and current time is between 9:00 pm and 10:00 pm, the terminal device 2 can determine the “state right before sleep” is the state parameters of the terminal device 2.

In other embodiments, the terminal device 2 can determine in which country the terminal device 2 is currently located, according to the position information detected by the detecting device such as the GPS device of the detecting unit 25. For example, when the terminal device 2 determines the terminal device 2 is currently located in India, the terminal device 2 send the server 1 a message that the terminal device 2 is currently located in India, the server 1 then recommends an audio file having a style of India or a music playlist corresponding to audio files having the style of India to the terminal device 2. For another example, when the terminal device 2 determines the terminal device 2 is currently located in Japan, the terminal device 2 send the server 1 a message that the terminal device 2 is currently located in Japan, the server 1 then recommends an audio file that is popular in Japan or a music playlist corresponding to audio files that are popular in Japan to the terminal device 2. In at least one embodiment, the music playlist may include, but is not limited to popular songs in a ranking list of Japan, music televisions (e.g. MTV) in a ranking list of Japan, and classic songs in a ranking list of Japan. For another example, when the terminal device 2 determines the terminal device 2 is currently located in Chiufen of Taiwan, the terminal device 2 sends the server 1 a message that the terminal device 2 is currently located in Chiufen of Taiwan, the server 1 then recommends an audio file that is popular in Chiufen of Taiwan or a music playlist corresponding to audio files that are popular in Chiufen of Taiwan to the terminal device 2. For another example, when the terminal device 2 determines the terminal device 2 is currently located in Taidong of Taiwan, the terminal device 2 sends the server 1 a message that the terminal device 2 is currently located in Taidong of Taiwan, the server 1 recommends songs of singers who are born in Taidong of Taiwan. For example, the server 1 recommends an audio file of Huimei Zhang or a music playlist corresponding to audio files of Huimei Zhang to the terminal device 2. In at least one embodiment, the terminal device 2 can determine a current position according to the position information detected by the detecting device such as the GPS device of the detecting unit 25. The terminal device 2 can further determine a geographic range based on the current position. The terminal device 2 can determine an audio file or a music playlist that is currently listened by a user of the server 1 who is located in the geographic range. The user can share the audio files or the music playlist through the server 1.

In at least one embodiment, the generating module 111 can generate a music playlist corresponding to the received state parameters and/or the received preference parameters, according to the received state parameters and/or the received preference parameters. The generating module 111 can further store the generated music playlist in the storage device 13, and send the generated music playlist to the terminal device 2. In other embodiments, when the terminal device 2 successfully logs into the server 1 without the account, the generating module 111 can generate the music playlist corresponding to the received state parameters and/or the received preference parameters. The transceiver module 110 sends the generated music playlist to the terminal device 2 through the first communication device 14.

In at least one embodiment, the terminal device 2 can receive the generated music playlist through the second communication device 23. The processor 22 can play audio files corresponding to the generated music playlist. In at least one embodiment, the audio files corresponding to the generated music playlist are stored in the storage device 13 of the server 1. When the audio files corresponding to the generated music playlist are played using the audio unit 26, the server 1 can send the audio files corresponding to the generated music playlist to the terminal device 2 through a wireless communication connection, which is established between the first communication device 14 and the second communication device 23 through the network 3. In at least one embodiment, the audio files corresponding to the generated music playlist can be streaming compression data, and can be stored in the server 1. The server 1 can send the streaming compression data to the terminal device 2 through the wireless communication connection. The processor 22 can decompress the streaming compression data. The decompressed streaming compression data are outputted by the audio unit 26. In at least one embodiment, the streaming compression data can be audio files similar to the real audio, MS media player, or apple quick time. In other embodiments, some or all of the audio files corresponding to the generated music playlist are stored in the terminal device 2. When the terminal device 2 receives the generated music playlist through the second communication device 23, if some or all of the audio files corresponding to the generated music playlist that are stored in the terminal device 2, the processor 22 can directly play the some or all of the audio files that are stored in the terminal device 2. If some or all of the audio files corresponding to the generated music playlist are not stored in the terminal device 2, the server 1 can send the some or all of the audio files that are not stored in the terminal device 2 to the terminal device 2 through the wireless communication connection.

In other embodiments, when the terminal device 2 receives the generated music playlist from the server 1, the terminal device 2 can compare the audio files corresponding to the generated music playlist with audio files that are stored in the terminal device 2. If the audio files corresponding to the generated music playlist are stored in the terminal device 2, the terminal device 2 can adjust a play order of playing the audio files corresponding to the generated music playlist. For example, a sequence of playing an audio file that is stored in the terminal device 2 can be adjusted to be before a sequence of playing an audio file that is stored in the server 1. In other embodiments, if the audio files corresponding to the generated music playlist are stored in the terminal device 2, the terminal device 2 can adjust the play order according to a communication quality of the network 3. For example, if the communication quality of the network 3 is not good for transmitting the streaming compression data from the server 1 to the terminal device 2, the sequence of playing the audio file that is stored in the terminal device 2 can be adjusted to be before the sequence of playing the audio file that is stored in the server 1. When the transceiver module 110 detects that the communication quality of the network 3 is good for transmitting the streaming compression data, the transceiver module 110 sends the streaming compression data to the terminal device 2 through the network 3. The terminal device 2 plays the audio files received from the server 1.

In at least one embodiment, the generating module 111 can query the audio files corresponding to the received state parameters and/or the received preference parameters, by searching the related information stored in the storage device 13 according to the received state parameters and/or the received preference parameters. The generating module 111 can select a first predetermined number of audio files from the queried audio files randomly or according to a predetermined method. Then the generating module 111 can generate the music playlist according to the first predetermined number of audio files, and send the generated music playlist to the terminal device 2. For example, when the received state parameters of the terminal device 2 is the “state in working”, and the received three groups of preference parameters include a first group of preference parameters that the singer is “A”, a second group of preference parameters that the singer is “B”, and a third group of preference parameters that the style is the rock style. The generating module 111 can firstly query first audio files that corresponds to the singer “A” and the signer “B”, by searching the storage device 13 according to the first and the second groups of preference parameters. The generating module 111 can determine second audio files whose style are rock styles from the first audio files, according to the third group of preference parameters. The generating module 111 can further determine third audio files whose states are the “state in working” from the second audio files. The generating module 111 can determine the third audio files to be the audio files that correspond to the received state parameters and/or the received preference parameters.

In at least one embodiment, the generated music playlist can include, but is not limited to, a name, a singer's name, time length, and a picture of each of the first predetermined number of audio files that are used to generate the music playlist.

In at least one embodiment, when the received preferred parameters includes the target of sport such as the target time length of sport, the generating module 111 can select a second predetermined number of audio files from the first predetermined number of audio files. The generating module 111 can generate the music playlist according to the second predetermined number of audio files. In at least one embodiment, a total time length of all the second predetermined number of audio files is substantially equal to the target time length of sport. In other words, a difference value between the total time length of all the second predetermined number of audio files and the target time length of sport is within a preset range of time length such as (−20 seconds, 20 seconds).

The detecting module 112 can determine whether at least one group of dynamic parameters is received from the terminal device 2. In at least one embodiment, the at least one group of dynamic parameters (hereinafter also referred to as “the received dynamic parameters”) can be related to the terminal device 2. The detecting module 112 can record initial time and/or an initial position of the terminal device 2 when the terminal device 2 plays the audio files corresponding to the generated music playlist. The detecting module 112 can periodically inform the terminal device 2 to obtain the at least one group of dynamic parameters. In at least one embodiment, the at least one group of dynamic parameters can be selected from a group including played time length of at least one audio file of a current music playlist of the terminal device 2, the physiological parameters of the user of the terminal device 2, movement parameters of the terminal device 2, or a combination of the played time length, the physiological parameters of the user of the terminal device 2, and the movement parameters. In at least one embodiment, the played time length can be defined to be time length that an audio file has been played for, when the terminal device 2 switches from the audio file to another audio file corresponding to the current music playlist.

In at least one embodiment, the detecting module 112 can periodically inform the terminal device 2 to record the played time length of each of the audio files corresponding to the current music playlist, and record the physiological parameters of the user of the terminal device 2. The detecting module 112 can periodically obtain the played time length and the physiological parameters of the user of the terminal device 2. The terminal device 2 can detect the physiological parameters of the user of the terminal device 2 using the processor 22 and the detecting unit 25. The terminal device 2 can further send the physiological parameters of the user of the terminal device 2 to the server 1. When the terminal device 2 sets the one or more targets of sport, the detecting module 112 can inform the terminal device 2 to obtain a current position and a current movement speed value of the terminal device 2, and/or a value of consumed calories of the user of the terminal device 2.

When the dynamic parameters is received from the terminal device 2, the adjusting module 113 can adjust the current music playlist according to the received dynamic parameters and obtain an adjusted music playlist. The adjusting module 113 can further send the adjusted music playlist to the terminal device 2. The terminal device 2 can play audio files corresponding to the adjusted music playlist. In at least one embodiment, the adjusting module 113 can determine whether the current music playlist needs to be adjusted by comparing the received dynamic parameters with a corresponding preset value.

When the received dynamic parameters is the played time length, the adjusting module 113 can determine whether the played time length is less than preset time length. When the played time length is less than the preset time length, the adjusting module 113 can delete a played audio file whose played time length is less than the preset time length from the current music playlist. In at least one embodiment, the terminal device 2 has played the deleted audio file. In at least one embodiment, when the played time length is less than 10 seconds, the adjusting module 113 can give “−10” points to the deleted audio files. Similarly, when the played time length is great than 30 seconds, the adjusting module 113 can give “−5” points to the deleted audio files. In at least one embodiment, the adjusting module 113 can generate an updated music playlist when total points of all the deleted audio files are greater than preset points such as 100 points. In other embodiment, when an audio file is deleted from the current music playlist, the adjusting module 113 can further query audio files that are corresponding to the received state parameters and/or the received preferred parameters. The adjusting module 113 can further select one or more audio files from the queried audio files, and add the one or more audio files to the current music playlist.

In at least one embodiment, when the received dynamic parameters is the physiological parameter of the user of the terminal device 2, the adjusting module 113 can search an audio file matching the physiological parameter from the current music playlist. The adjusting module 113 can further determine the searched audio file to be played next. If there is no audio file matching the physiological parameter can be found from the current music playlist by the adjusting module 113, the adjusting module 113 can select one audio file matching the physiological parameter from the audio files corresponding to the received state parameters and/or the received preferred parameters. The adjusting module 113 can further add the selected audio file to the current music playlist and determine the selected audio file to be played next.

For example, if the received dynamic parameters is the heart rate, the blood pressure value, the temperature value, or the number of walk steps of the user of the terminal device 2, the adjusting module 113 can determine whether the received dynamic parameters is greater than a corresponding first preset value, In at least one embodiment, when the received dynamic parameters (i.e., the heart rate, the blood pressure value, the temperature value, or the number of walk steps of the user of the terminal device 2) is greater than the corresponding first preset value, the adjusting module 113 can determine the user needs to listen an audio file whose rhythm is slow enough to match the received dynamic parameters (In other embodiments, the adjusting module 113 can determine the user needs to listen an audio file whose rhythm is fast enough to match the received dynamic parameters). The adjusting module 113 can determine an audio file corresponding to the current music playlist whose rhythm is slow enough to match the received dynamic parameters to be played next. If there is no audio file whose rhythm is slow enough to match the received dynamic parameters can be found from the current music playlist, the adjusting module 113 can select one audio file whose rhythm is slow enough to match the received dynamic parameters from the audio files corresponding to the received state parameters and/or the received preferred parameters. The adjusting module 113 can add the selected audio file to the current music playlist, and determine the selected audio file be played next. In other embodiments, when the received dynamic parameters (i.e., the heart rate, the blood pressure value, the temperature value, or the number of walk steps of the user of the terminal device 2) is less than the corresponding first preset value, the adjusting module 113 can determine whether the received dynamic parameters is also less than a corresponding second preset value. In at least one embodiment, the corresponding second preset value is less than the corresponding first preset value. When the received dynamic parameters is less than the corresponding second preset value, the adjusting module 113 can determine the user needs to listen an audio file whose rhythm is fast enough to match the received dynamic parameters (In other embodiments, the adjusting module 113 can determine the user needs to listen an audio file whose rhythm is slow enough to match the received dynamic parameters). Similarly, the adjusting module 113 can determine an audio file corresponding to the current music playlist whose rhythm is fast enough to match the received dynamic parameters to be played next. If there is no audio file whose rhythm is fast enough to match the received dynamic parameters can be found from the current music playlist, the adjusting module 113 can select one audio file whose rhythm is fast enough to match the received dynamic parameters from the audio files corresponding to the received state parameters and/or the received preferred parameters. The adjusting module 113 can add the selected audio file to the current music playlist, and determine the selected audio file be played next. Therefore, it makes the dynamic parameters such as the heart rate, the blood pressure value, the temperature value, or the other dynamic parameters such as the number of walk steps of the user of terminal device 2 can be adjusted accordingly.

Similarly, when the received dynamic parameters is the “state right before sleep”, the adjusting module 113 can search an audio file whose rhythm is slow from audio files corresponding to the current music playlist, and determine the searched audio file to be played next. If there is no audio file whose rhythm is slow can be found from the audio files corresponding to the current music playlist by the adjusting module 113, the adjusting module 113 can select one audio file whose rhythm is slow from the audio files corresponding to the received stated state parameters and/or the received preferred parameters. The adjusting module 113 can further add the selected audio file to the current music playlist and determine the selected audio file to be played next. In other embodiments, when the received dynamic parameters is a sleep state, the terminal device 2 can stop playing the audio files corresponding to the current music playlist.

In at least one embodiment, when the received dynamic parameters is parameters of sport, the adjusting module 113 can determine an amount of unfinished sport by comparing the received dynamic parameters and the preset targets of sport. When total time length of all audio files corresponding to the current music playlist that are not played is less than a remaining time length spent on the amount of unfinished sport, the adjusting module 113 can calculate time length difference between the total time length of all the audio files corresponding to the current music playlist that are not played yet and the remaining time length. The adjusting module 113 can select one or more audio files whose time length matching the calculated time difference, from the audio files corresponding to the received state parameters and/or the received preferred parameters. The adjusting module 113 can add the one or more selected audio files to the current music playlist. In at least one embodiment, the one or more audio files whose time length matching the calculated time length difference can be defined to be time length difference between time length of each of the one or more audio files and time length spent on the amount of unfinished sport is less than a predetermined value such as 10 seconds.

When the received dynamic parameters is the target value of consumed calories, the adjusting module 113 can determine whether the current music playlist needs to add audio files, according to the initial time, time when the consumed calories is received from the terminal device 2, the consumed calories, and the target value of consumed calories. For example, the adjusting module 113 can calculate a value of consumed calories per one minute according to the initial time, the time when the consumed calories is received, and the consumed calories. The adjusting module 113 can determine a difference value of calories between the target value of consumed calories and the consumed calories. The adjusting module 113 can further calculate time length for consuming the difference value of calories according to the value of consumed calories per one minute. If the calculated time length is less than or equal to the total time length of all audio files corresponding to the current music playlist that are not played, the adjusting module 113 can keep the current music playlist and not adjust the current music playlist. If the calculated time length is greater than the total time length of all audio files corresponding to the current music playlist that are not played, the adjusting module 113 can calculate a difference value of time length between the total time length of all audio files corresponding to the current music playlist that are not played and the calculated time length. The adjusting module 113 can select an audio file that corresponds to the calculated difference value of time length from the audio files corresponding to the received state parameters and/or the received preferred parameters. The adjusting module 113 can further add the selected audio file to the current music playlist. In at least one embodiment, a difference value of time length between the time length of the selected audio file and the calculated difference value of time length is less than a preset value such as 10 seconds.

In at least one embodiment, when the received dynamic parameter is the current position and the current movement speed value of the terminal device 2, the adjusting module 113 can determine a distance value of the terminal device 2 has travelled, according to the initial position and the current position of the terminal device 2. The adjusting module 113 can further determine whether the current music playlist needs to add audio files according to the distance value of the terminal device 2 has travelled, the current movement speed value of the terminal device 2, and the target value of distance. For example, the adjusting module 113 can determine a difference value of distance between the target value of distance and the distance value of the terminal device 2 has travelled. The adjusting module 113 can calculate time length spent on travelling the difference value of distance. If the calculated time length is less than or equal to the total time length of audio files corresponding to the current music playlist that are not played, the adjusting module 113 can keep the current music playlist, and not adjust the current music playlist. If the calculated time length is greater than the total time length of audio files corresponding to the current music playlist that are not played, the adjusting module 113 can calculate a difference value of time length between the total time length of audio files corresponding to the current music playlist that are not played and the calculated time length. The adjusting module 113 can select an audio file that corresponds to the calculated difference value of time length from the audio files corresponding to the received state parameters and/or the received preferred parameters. The adjusting module 113 can further add the selected audio file to the current music playlist. In at least one embodiment, a difference value of time length between the time length of the selected audio file and the calculated difference value of time length is less than a preset value such as 10 seconds.

In other embodiments, the adjusting module 113 can further determine current state parameters of the terminal device 2 according to the received dynamic parameters. The adjusting module 113 can determine whether the current music playlist of the terminal device 2 needs to be adjusted according to the current state parameters. When the current state parameters matches the received state parameters, the adjusting module 113 can keep the current music playlist and not adjust the current music playlist. When the current state parameters does not match the received state parameters, the adjusting module 113 can re-search audio files from the server 1 according to the current state parameters and the received preferred parameters. The adjusting module 113 can select a plurality of audio files from the re-searched audio files, and generate an updated music playlist according to the selected plurality of audio files.

In at least one embodiment, the adjusting module 113 can determine the current state parameters according to the current position, the current movement speed value, and/or current time. For example, the adjusting module 113 can determine whether the current position matches position information of the received state parameters. In at least one embodiment, the adjusting module 113 can calculate a distance value between the current position and the position information of the received state parameters. When the calculated distance value is less than or equal to a preset distance value, such as 1 kilometer, the adjusting module 113 can determine the current position matches the position information of the received state parameters. The adjusting module 113 can keep the current music playlist of the terminal device 2 and not adjust the current music playlist. When the calculated distance value is greater than the preset distance value, the adjusting module 113 can determine the current position does not match the position information of the received state parameters. The adjusting module 113 can determine a current state of the terminal device 2 according to the current position and/or the current movement speed value of the terminal device 2. For example, the adjusting module 113 can determine the terminal device 2 is in a state of exercise, according to parameters of the terminal device 2 such as the terminal device 2 is in the gym, in the stadium, and/or moving at a certain speed value. The adjusting module 113 can further determine the “state in exercising” is the state parameters of the terminal device 2.

The processing module 114 can determine whether the terminal device 2 is disconnected with the server 1. If the terminal device 2 is disconnected with the server 1, the processing module 114 can store the music playlist that has been sent to the terminal device 2 in the storage device 13. In at least one embodiment, the music playlist that has been sent to the terminal device 2 includes the originally generated music playlist, and/or the updated music playlist. In other embodiments, the processing module 114 can further store, in the storage device 13, the state parameters, the preferred parameters, and/or the dynamic parameters corresponding to the music playlist that has been sent to the terminal device 2. In at least one embodiment, when the terminal device 2 logs into the server 1 using the account information, the processing module 114 can establish a relationship between the music playlist that has been sent to the terminal device 2, the state parameters, the preferred parameters, and/or the dynamic parameters, and/or the account information corresponding to the music playlist that has been sent to the terminal device 2.

In at least one embodiment, the processing module 114 can periodically query or receive the related information corresponding to each of the plurality of audio files stored in the storage device 13. In at least one embodiment, the related information may include, but is not limited to, activity information such as time, a position, a ticket selling method corresponding to each of the plurality of audio files stored in the storage device 13. The processing module 114 can further send the queried related information related information to the terminal device 2 whose current music playlist including one or more audio files corresponding to the related information.

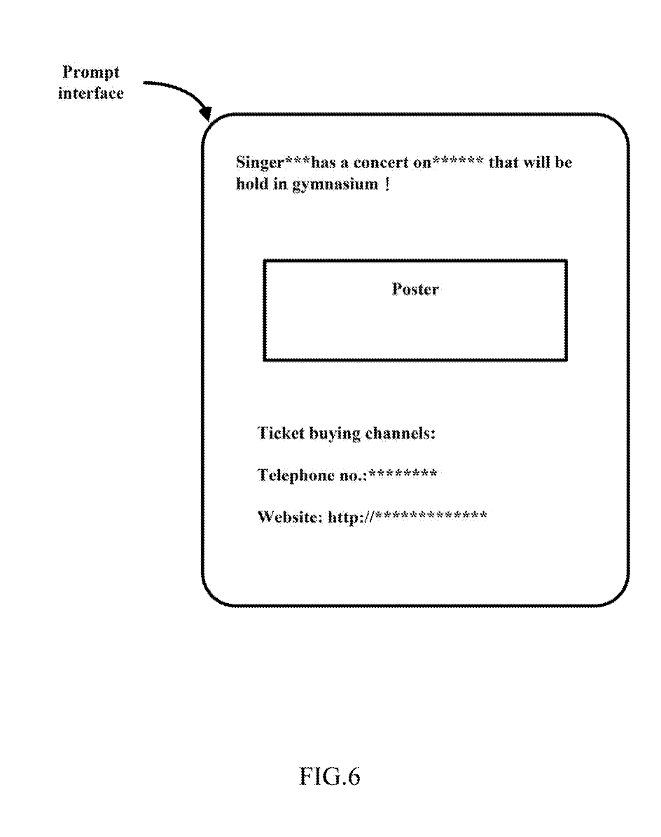

For example, as shown in FIG. 6, when the terminal device 2 reconnects with the server 1, the processing module 114 can send a prompt interface to the terminal device 2 and display the prompt interface on the display device 24 of the terminal device 2. In at least one embodiment, the prompt interface is used to prompt the related information to the user. In at least one embodiment, the prompt interface may include content of the activity information, a link of the activity information.

In at least one embodiment, when the terminal device 2 switches from a first audio file to a second audio file that are corresponding to the current music playlist, the adjusting module 113 can give predetermined points to the first audio file, according to played time length of the first audio file when the terminal device 2 switches from the first audio file to the second audio file. In at least one embodiment, the played time length can be defined to be time length that an audio file has been played for, when the terminal device 2 switches from the audio file to another audio file corresponding to the current music playlist. The adjusting module 113 can set the predetermined points to be additional information of the first audio file. For example, if the terminal device 2 switches from the first audio file to the second audio file when the first audio file has been played for 10 seconds, then the adjusting module 113 can give 10 points to the first audio file. For another example, if the terminal device 2 switches from the first audio file to the second audio file when the first audio file has been played for 20 seconds, then the adjusting module 113 can give 20 points to the first audio file. Similarly, if the terminal device 2 switches from the first audio file to the second audio file when the first audio file has been played for 120 seconds, then the adjusting module 113 can give 120 points to the first audio file. In at least one embodiment, the adjusting module 113 can update total points of each of audio files that has been played by the terminal device 2, according to a number of replayed times of each of audio files that has been played by the terminal device 2. For example, if the first audio file has replayed for one time, i.e., the first audio file has played for two times in total, the adjusting module 113 can update the total points of the first audio file by multiplying current total points of the first audio file by 2. For another example, if the first audio file has replayed for two times, i.e., the first audio file has played for three times in total, the adjusting module 113 can update the total points of the first audio file by multiplying current total points of the first audio file by 3. Therefore, any audio file has played using the terminal device 2 can have the additional information. Accordingly, a preference degree corresponding to each of the audio files that has been played by the terminal device 2 can be measured using the additional information corresponding to each of the audio files. In at least one embodiment, when the processor 12 of the sever 1 selects a predetermined number of audio files from the audio files to generate a music playlist, the processor 12 can select the predetermined number of audio files according to the total points corresponding to each of the audio files. For example, the processor 12 can select the predetermined number of audio files whose total points are greater than preset number of points.

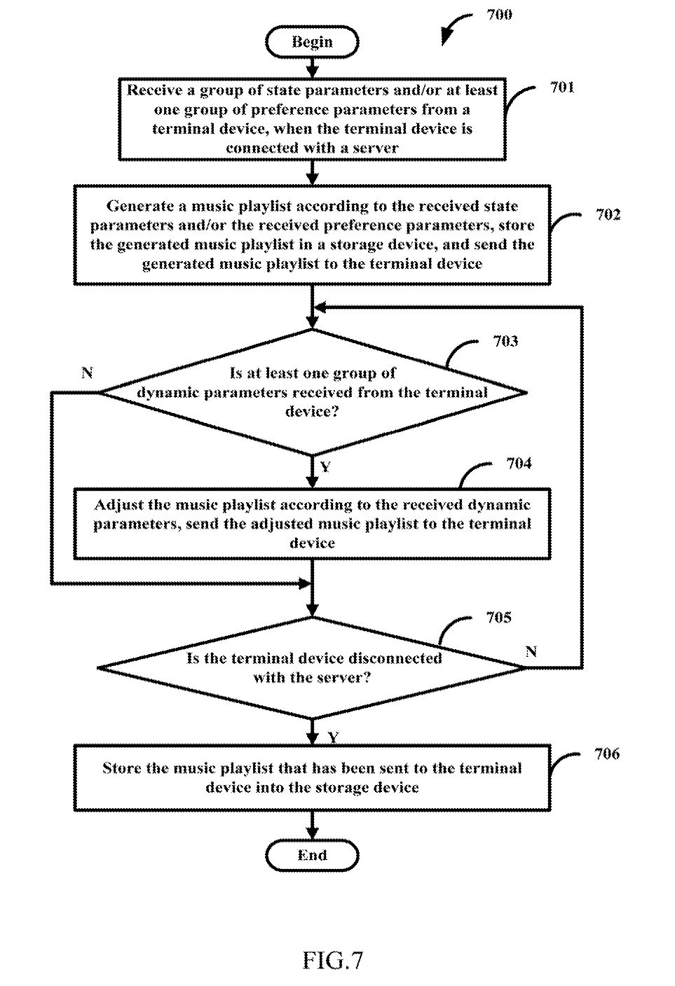

FIG. 7 illustrates a flowchart of one embodiment of providing music service. The example method 700 is provided by way of example, as there are a variety of ways to carry out the method. The method 700 described below can be carried out using the configurations illustrated in FIG. 1 and FIG. 2, for example, and various elements of these figures are referenced in explaining example method 700. Each block shown in FIG. 7 represents one or more processes, methods or subroutines, carried out in the exemplary method 700. Additionally, the illustrated order of blocks is by example only and the order of the blocks can be changed according to the present disclosure. The exemplary method 700 can begin at block 701. Depending on the embodiment, additional steps can be added, others removed, and the ordering of the steps can be changed.

At block 701, when the terminal device 2 is connected with the server 1, the transceiver module 110 can receive a group of state parameters and/or at least one group of preference parameters from the terminal device 2. In at least one embodiment, the terminal device 2 can log into the server 1 by sending the account information to the server 1. In other embodiments, the terminal device 2 can log into the server 1 directly, i.e., the terminal device 2 is no need to send the account information to the server 1.

In at least one embodiment, when the terminal device 2 is connected with the server 1, the transceiver module 110 can send the terminal device 2, a first setting interface for setting/selecting state parameters and/or a second setting interface for setting/selecting preference parameters. The transceiver module 110 can further display the first setting interface and the second interface on the display device 24 of the terminal device 2. The transceiver module 110 can receive the state parameters selected from the first setting interface by the terminal device 2, and/or receive the preference parameters selected from the second setting interface by the terminal device 2. In at least one embodiment, the first setting interface can provide the user with multiple groups of different state parameters for selecting. The user can select one group of state parameters from the multiple groups of different state parameters using the inputting device 21 of the terminal device 2, according to a current state of the user. In at least one embodiment, the second setting interface can provide the user with multiple groups of preference parameters for selecting. In at least one embodiment, the multiple groups of preference parameters can include, but are not limited to, parameters of preferred song, parameters of preferred style, parameters of preferred emotion, parameters of preferred mood, parameters of preferred rhythm, and parameters of preferred sport. Each of the preference parameters can include a plurality of options for the terminal device 2 to choose. The user of the terminal device 2 can select at least one group of preference parameters by choosing one or more options of each of the preference parameters.

In at least one embodiment, the terminal device 2 can detect various data using the detecting unit 25. For example, the various data can include, but are not limited to, speed information (e.g., a static state, a walking state, a running state, a bicycling state, or a driving state), position information, time information and/or a combination of the speed information, the position information, and time information. The terminal device 2 can determine a current state of the terminal device 2 by processing the detected data according to logical operations. The terminal device 2 can further determine state parameters of the terminal device 2 according to the current state of the terminal device 2, and send the state parameters of the terminal device 2 to the server 1. For example, the terminal device 2 can determine whether the terminal device 2 is currently at a gymnasium, a stadium, at home, at a gathering place, or in an office according to position information detected by a first detecting device such as a GPS device of the detecting unit 25. The terminal device 2 can determine whether the terminal device 2 is static or moving with a speed value according to data detected by a second detecting device such as a three-axis acceleration sensor of the detecting unit 25. The terminal device 2 can further determine whether the terminal device 2 is in a state right before sleep according to current time information.

At block 702, the generating module 111 can generate a music playlist corresponding to the received state parameters and/or the received preference parameters, according to the received state parameters and/or the received preference parameters. The generating module 111 can further store the generated music playlist in the storage device 13, and send the generated music playlist to the terminal device 2. The terminal device 2 can receive the generated music playlist through the second communication device 23. The processor 22 can play audio files corresponding to the generated music playlist. In at least one embodiment, when the audio files corresponding to the generated music playlist are played using the audio unit 26, the server 1 can send the audio files corresponding to the generated music playlist to the terminal device 2 through a wireless communication connection, which is established between the first communication device 14 and the second communication device 23 through the network 3. In at least one embodiment, the audio files corresponding to the generated music playlist can be streaming compression data, and can be stored in the server 1. The server 1 can send the streaming compression data to the terminal device 2 through the wireless communication connection. The processor 22 can decompress the streaming compression data. The decompressed streaming compression data are outputted by the audio unit 26.

In at least one embodiment, the generating module 111 can query the audio files corresponding to the received state parameters and/or the received preference parameters, by searching the related information stored in the storage device 13 according to the received state parameters and/or the received preference parameters. The generating module 111 can select a first predetermined number of audio files from the queried audio files. Then the generating module 111 can generate the music playlist according to the first predetermined number of audio files, and send the generated music playlist to the terminal device 2. In at least one embodiment, the generated music playlist can include, but is not limited to, a name, a singer's name, time length, and a picture of each of the first predetermined number of audio files that are used to generate the music playlist.

In at least one embodiment, when the received preferred parameters includes the target of sport such as the target time length of sport, the generating module 111 can select a second predetermined number of audio files from the first predetermined number of audio files. The generating module 111 can generate the music playlist according to the second predetermined number of audio files. In at least one embodiment, a total time length of all the second predetermined number of audio files is substantially equal to the target time length of sport. In other words, a difference value between the total time length of all the second predetermined number of audio files and the target time length of sport is within a preset range of time length such as (−20 seconds, 20 seconds).

At block 703, the detecting module 112 can determine whether at least one group of dynamic parameters is received from the terminal device 2. When the at least one group of dynamic parameters is received from the terminal device 2, the process goes to block 704. When the at least one group of dynamic parameters is not received from the terminal device 2, the process goes to block 705.

In at least one embodiment, when the terminal device 2 plays the audio files corresponding to the generated music playlist, the detecting module 112 can record initial time and/or an initial position of the terminal device 2. The detecting module 112 can periodically inform the terminal device 2 to obtain the at least one group of dynamic parameters (hereinafter also referred to as the received dynamic parameters). In at least one embodiment, the at least one group of dynamic parameters can include, but are not limited to, played time length, the physiological parameters of the user of the terminal device 2, and/or movement parameters of the terminal device 2. In at least one embodiment, the played time length can be defined to be time length that an audio file has been played for, when the terminal device 2 switches from the audio file to another audio file corresponding to the current music playlist.

In at least one embodiment, the detecting module 112 can periodically inform the terminal device 2 to record the played time length of each of the audio files corresponding to the current music playlist, and record the physiological parameters of the user of the terminal device 2. The detecting module 112 can periodically obtain the played time length and the physiological parameters of the user of the terminal device 2. The terminal device 2 can detect the physiological parameters of the user of the terminal device 2 using the processor 22 and the detecting unit 25. The terminal device 2 can further send the physiological parameters of the user of the terminal device 2 to the server 1. When the terminal device 2 sets the one or more targets of sport, the detecting module 112 can inform the terminal device 2 to obtain a current position and a current movement speed value of the terminal device 2, and/or a value of consumed calories of the user of the terminal device 2.

At block 704, when the dynamic parameters is received from the terminal device 2, the adjusting module 113 can adjust the music playlist according to the received dynamic parameters. The adjusting module 113 can further send the adjusted music playlist to the terminal device 2. The terminal device 2 can play audio files corresponding to the adjusted music playlist. In at least one embodiment, the adjusting module 113 can determine whether the current music playlist needs to be adjusted by comparing the received dynamic parameters with a corresponding preset value.

When the received dynamic parameters is the played time length, the adjusting module 113 can determine whether the played time length is less than preset time length. When the played time length is less than the preset time length, the adjusting module 113 can delete a played audio file whose played time length is less than the preset time length from the current music playlist. In at least one embodiment, the terminal device 2 has played the deleted audio file. In at least one embodiment, when the received dynamic parameters is the physiological parameter of the user of the terminal device 2, the adjusting module 113 can search an audio file matching the physiological parameter from the current music playlist. The adjusting module 113 can further determine the searched audio file to be played next. If there is no audio file corresponding to the physiological parameter can be found from the current music playlist by the adjusting module 113, the adjusting module 113 can select one audio file that corresponds to the physiological parameter from the audio files corresponding to the received state parameters and/or the received preferred parameters. The adjusting module 113 can further add the selected audio file to the current music playlist and determine the selected audio file to be played next. In at least one embodiment, when the received dynamic parameters is parameters of sport, the adjusting module 113 can determine a remaining time length spent on an amount of unfinished sport by comparing the received dynamic parameters and the preset targets of sport. When total time length of all audio files corresponding to the current music playlist that are not played is less than the remaining time length, the adjusting module 113 can calculate time length difference between the total time length of all the audio files corresponding to the current music playlist that are not played and the remaining time length. The adjusting module 113 can select one or more audio files whose time length matching the calculated time difference, from the audio files corresponding to the received state parameters and/or the received preferred parameters. The adjusting module 113 can add the one or more selected audio files to the current music playlist. In at least one embodiment, the one or more audio files whose time length matching the calculated time length difference can be defined to be time length difference between time length of each of the one or more audio files and time length spent on the amount of unfinished sport is less than a predetermined value such as 10 seconds.

In other embodiments, the adjusting module 113 can further determine current state parameters of the terminal device 2 according to the received dynamic parameters. The adjusting module 113 can determine whether the current music playlist of the terminal device 2 needs to be adjusted according to the current state parameters. When the current state parameters matches the received state parameters, the adjusting module 113 can keep the current music playlist and not adjust the current music playlist. When the current state parameters does not match the received state parameters, the adjusting module 113 can re-search audio files from the server 1 according to the current state parameters and the received preferred parameters. The adjusting module 113 can select a plurality of audio files from the re-searched audio files. The adjusting module 113 can generate an updated music playlist according to the selected plurality of audio files.

At block 705, the processing module 114 can determine whether the terminal device 2 is disconnected with the server 1. If the terminal device 2 is disconnected with the server 1, the process goes to block 706. If the terminal device 2 is connected with the server 1, the process goes back to block 703.

At block 706, the processing module 114 can store, in the storage device 13, the music playlist that has been sent to the terminal device 2. In at least one embodiment, the music playlist that has been sent to the terminal device 2 includes the originally generated music playlist, and/or the updated music playlist. In other embodiments, the processing module 114 can further store, in the storage device 13, the state parameters, the preferred parameters, and/or the dynamic parameters corresponding to the music playlist that has been sent to the terminal device 2. In at least one embodiment, when the terminal device 2 logs into the server 1 using the account information, the processing module 114 can establish a relationship between the music playlist that has been sent to the terminal device 2, the state parameters, the preferred parameters, the dynamic parameters, and/or the account information corresponding to the music playlist that has been sent to the terminal device 2. The processing module 114 can display a music playlist and corresponding state parameters and/or preferred parameters on a page for sharing the music playlist and corresponding state parameters and/or preferred parameters with other users.

It should be noted that the method of providing music service is not limited as illustrated in FIG. 7. Depending on the embodiment, additional steps can be added, others removed, and the ordering of the steps can be changed. For example, the block 701 and the block 702 can be removed, and changed the process to be the server 1 generates the music playlist randomly and sends the music playlist to the terminal device 2. In other words, the server 1 can generate the music playlist without the state parameters and/or the preferred parameters, and send the music playlist to the terminal device 2.

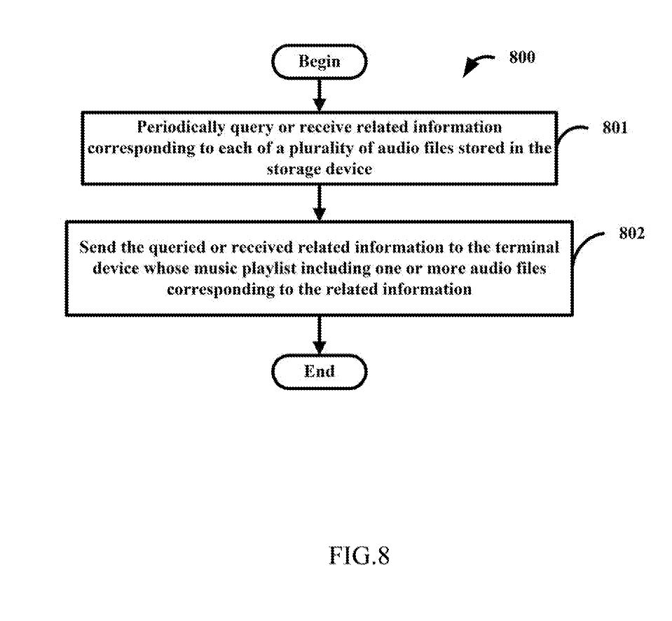

FIG. 8 illustrates a flowchart of one embodiment of sharing related information. The example method 800 is provided by way of example, as there are a variety of ways to carry out the method. The method 800 described below can be carried out using the configurations illustrated in FIG. 1 and FIG. 2, for example, and various elements of these figures are referenced in explaining example method 800. Each block shown in FIG. 8 represents one or more processes, methods or subroutines, carried out in the exemplary method 800. Additionally, the illustrated order of blocks is by example only and the order of the blocks can be changed according to the present disclosure. The exemplary method 800 can begin at block 801. Depending on the embodiment, additional steps can be added, others removed, and the ordering of the steps can be changed.

At block 801, the processing module 114 can periodically query or receive the related information corresponding to each of the plurality of audio files stored in the storage device 13. In at least one embodiment, the related information may include, but is not limited to, activity information such as time, a position, a ticket selling method corresponding to each of the plurality of audio files stored in the storage device 13.

At block 802, the processing module 114 can further send the queried or received related information to the terminal device 2 whose music playlist including one or more audio files corresponding to the related information. When the terminal device 2 reconnects with the server 1, the processing module 114 can send a prompt interface to the terminal device 2 and display the prompt interface on the display device 24 of the terminal device 2. In at least one embodiment, the prompt interface is used to prompt the related information to the user. In at least one embodiment, the prompt interface may include content of the activity information, a link of the activity information.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A method for providing music service to a terminal device using a server, the method comprising:
generating a music playlist;
sending the music playlist to the terminal device;
determining whether at least one group of dynamic parameters is received from the terminal device;
adjusting the music playlist according to the at least one group of dynamic parameters when the at least one group of dynamic parameters is received, and obtaining an adjusted music playlist; and
sending the adjusted music playlist to the terminal device.

2. The method according to claim 1, further comprising:
when a group of state parameters or at least one group of preferred parameters is received from the terminal device, obtaining received state parameters or received preferred parameters and generating the music playlist according to the received state parameters or the received preferred parameters, wherein the music playlist matches the received state parameters or the received preferred parameters.

3. The method according to claim 2, further comprising:
querying related information of a plurality of audio files that are stored in a storage device of the server, wherein the related information is selected from a group including a singer's name, an album's name, a style, an emotion, a mood, a rhythm, and a suitable state corresponding to each of the plurality of audio files;
obtaining first audio files, from the plurality of audio files that are stored in the storage device, that are matching the received state parameters and/or the received preferred parameters;
selecting a first predetermined number of audio files from the first audio files; and
generating the music playlist using the first predetermined number of audio files.

4. The method according to claim 2, further comprising:
determining a current state of a user of the terminal device according to the received state parameters.

5. The method according to claim 2, further comprising:
sending a first setting interface to the terminal device, wherein the first setting interface provides multiple groups of state parameters for selection; and/or
sending a second setting interface to the terminal device, wherein the second setting interface provides multiple groups of preferred parameters for selection.

6. The method according to claim 2, wherein the received state parameters are determined according to at least one of speed information, position information, and time information of the terminal device;
the at least one group of preference parameters comprises parameters that are selected from a group including parameters of preferred song, parameters of preferred style, parameters of preferred emotion, parameters of preferred mood, parameters of preferred rhythm, and parameters of preferred sport.

7. The method according to claim 3, wherein the at least one group of dynamic parameters is selected from a group including played time length of at least one audio file of a current music playlist of the terminal device, physiological parameters of a user of the terminal device, and movement parameters of the user.

8. The method according to claim 7, further comprising:
periodically obtaining the at least one group of dynamic parameters from the terminal device, when the terminal device has played audio files corresponding to a current music playlist; and
determining whether the current music playlist needs to be adjusted by comparing the at least one group of dynamic parameters with a corresponding preset value.

9. The method according to claim 8, further comprising:
determining whether the played time length is less than a preset time length, when the at least one group of dynamic parameters is the played time length of the audio file corresponding to the current music playlist; and
deleting a played audio file whose played time length is less than the preset time length from the current music playlist, when the played time length of the dynamic parameters is less than the preset time length.

10. The method according to claim 8, further comprising:
searching for an audio file matching a physiological parameter of the user of the terminal device from the current music playlist to obtain a searched audio file, when the at least one group of dynamic parameters is the physiological parameter, and determining the searched audio file to be played next;
selecting an audio file matching the physiological parameter from the server and obtaining a selected audio file, when none of the plurality of audio files in the current music playlist matches the physiological parameter; and
adding the selected audio file to the current music playlist.

11. The method according to claim 8, further comprising:
determining a remaining time length by comparing the current parameters of sport with preset targets of sport, when the received dynamic parameters are current parameters of sport of the terminal device;
calculating time length difference between total time length of audio files in the current music playlist that are not played yet and the remaining time length to obtain a calculated time length difference, when the total time length of the audio files in the current music playlist that are not played yet is less than the remaining time length;
selecting one or more audio files whose time lengths match the calculated time length difference from audio files corresponding to the received state parameters or from audio files corresponding to the received preferred parameters stored in the server, and obtaining one or more selected audio files; and
adding the one or more selected audio files to the current music playlist.

12. A server, comprising:
a storage device that stores one or more programs;
at least one processor; and
the one or more programs when executed by the at least one processor, cause the at least one processor to:
generate a music playlist;
send the music playlist to a terminal device;
determine whether at least one group of dynamic parameters is received from the terminal device;
adjust the music playlist according to the at least one group of dynamic parameters when the at least one group of dynamic parameters is received, and obtain an adjusted music playlist; and
send the adjusted music playlist to the terminal device.

13. The server according to claim 12, wherein the at least one processor is further caused to:
when a group of state parameters or at least one group of preferred parameters is received from the terminal device, obtain received state parameters or received preferred parameters and generate the music playlist according to the received state parameters or the received preferred parameters, wherein the music playlist matches the received state parameters or the received preferred parameters.

14. The server according to claim 13, wherein the at least one processor is further caused to:
query related information of a plurality of audio files that are stored in a storage device of the server, wherein the related information is selected from a group including a singer's name, an album's name, a style, an emotion, a mood, a rhythm, and a suitable state corresponding to each of the plurality of audio files;
obtain first audio files, from the plurality of audio files that are stored in the storage device, that are matching the received state parameters and/or the received preferred parameters;
select a first predetermined number of audio files from the first audio files; and
generate the music playlist using the first predetermined number of audio files.

15. The server according to claim 13, wherein the at least one processor is further caused to:
determine a current state of a user of the terminal device according to the received state parameters.

16. The server according to claim 13, wherein the at least one processor is further caused to:
send a first setting interface to the terminal device, wherein the first setting interface provides multiple groups of state parameters for selection; and/or
send a second setting interface to the terminal device, wherein the second setting interface provides multiple groups of preferred parameters for selection.

17. The server according to claim 13, wherein the received state parameters are determined according to at least one of speed information, position information, and time information of the terminal device;
the at least one group of preference parameters comprises parameters that are selected from a group including parameters of preferred song, parameters of preferred style, parameters of preferred emotion, parameters of preferred mood, parameters of preferred rhythm, and parameters of preferred sport.

18. The server according to claim 14, wherein the at least one group of dynamic parameters is selected from a group including played time length of at least one audio file of a current music playlist of the terminal device, physiological parameters of a user of the terminal device, and movement parameters of the user.

19. The server according to claim 18, wherein the at least one processor is further caused to:
periodically obtain the at least one group of dynamic parameters from the terminal device, when the terminal device has played audio files corresponding to a current music playlist; and
determine whether the current music playlist needs to be adjusted by comparing the at least one group of dynamic parameters with a corresponding preset value.

20. The server according to claim 19, wherein the at least one processor is further caused to:
determine whether the played time length is less than a preset time length, when the at least one group of dynamic parameters is the played time length of the audio file corresponding to the current music playlist; and
delete a played audio file whose played time length is less than the preset time length from the current music playlist, when the played time length of the dynamic parameters is less than the preset time length.

21. The server according to claim 19, wherein the at least one processor is further caused to:
search for an audio file matching a physiological parameter of the user of the terminal device from the current music playlist to obtain a searched audio file, when the at least one group of dynamic parameters is the physiological parameter, and determining the searched audio file to be played next;
select an audio file matching the physiological parameter from the server and obtain a selected audio file, when none of the plurality of audio files in the current music playlist matches the physiological parameter; and
add the selected audio file to the current music playlist.

22. The server according to claim 19, wherein the at least one processor is further caused to:
determine a remaining time length by comparing the current parameters of sport with preset targets of sport, when the received dynamic parameters are current parameters of sport of the terminal device;
calculate time length difference between total time length of audio files in the current music playlist that are not played yet and the remaining time length to obtain a calculated time length difference, when the total time length of the audio files in the current music playlist that are not played yet is less than the remaining time length;
select one or more audio files whose time lengths match the calculated time length difference from audio files corresponding to the received state parameters or from audio files corresponding to the received preferred parameters stored in the server, and obtain one or more selected audio files; and
add the one or more selected audio files to the current music playlist.

23. A non-transitory storage medium having stored thereon instructions that, when executed by a processor of a server, causes the processor to perform a method for providing music service, wherein the method comprises:
generating a music playlist;
sending the music playlist to a terminal device;
determining whether at least one group of dynamic parameters is received from the terminal device;
adjusting the music playlist according to the at least one group of dynamic parameters when the at least one group of dynamic parameters is received, and obtaining an adjusted music playlist; and
sending the adjusted music playlist to the terminal device.

24. The non-transitory storage medium according to claim 23, wherein the method further comprises:
when a group of state parameters or at least one group of preferred parameters is received from the terminal device, obtaining received state parameters or received preferred parameters and generating the music playlist according to the received state parameters or the received preferred parameters, wherein the music playlist matches the received state parameters or the received preferred parameters.

25. The non-transitory storage medium according to claim 24, wherein the method further comprises:
querying related information of a plurality of audio files that are stored in a storage device of the server, wherein the related information is selected from a group including a singer's name, an album's name, a style, an emotion, a mood, a rhythm, and a suitable state corresponding to each of the plurality of audio files;
obtaining first audio files, from the plurality of audio files that are stored in the storage device, that are matching the received state parameters and/or the received preferred parameters;
selecting a first predetermined number of audio files from the first audio files; and
generating the music playlist using the first predetermined number of audio files.

26. The non-transitory storage medium according to claim 24, wherein the method further comprises:
determining a current state of a user of the terminal device according to the received state parameters.

27. The non-transitory storage medium according to claim 24, wherein the method further comprises:
sending a first setting interface to the terminal device, wherein the first setting interface provides multiple groups of state parameters for selection; and/or
sending a second setting interface to the terminal device, wherein the second setting interface provides multiple groups of preferred parameters for selection.

28. The non-transitory storage medium according to claim 24, wherein the received state parameters are determined according to at least one of speed information, position information, and time information of the terminal device;
the at least one group of preference parameters comprises parameters that are selected from a group including parameters of preferred song, parameters of preferred style, parameters of preferred emotion, parameters of preferred mood, parameters of preferred rhythm, and parameters of preferred sport.

29. The non-transitory storage medium according to claim 25, wherein the at least one group of dynamic parameters is selected from a group including played time length of at least one audio file of a current music playlist of the terminal device, physiological parameters of a user of the terminal device, and movement parameters of the user.

30. The non-transitory storage medium according to claim 29, wherein the method further comprises:
periodically obtaining the at least one group of dynamic parameters from the terminal device, when the terminal device has played audio files corresponding to a current music playlist; and
determining whether the current music playlist needs to be adjusted by comparing the at least one group of dynamic parameters with a corresponding preset value.

31. The non-transitory storage medium according to claim 30, wherein the method further comprises:
determining whether the played time length is less than a preset time length, when the at least one group of dynamic parameters is the played time length of the audio file corresponding to the current music playlist; and
deleting a played audio file whose played time length is less than the preset time length from the current music playlist, when the played time length of the dynamic parameters is less than the preset time length.

32. The non-transitory storage medium according to claim 30, wherein the method further comprises:
searching for an audio file matching a physiological parameter of the user of the terminal device from the current music playlist to obtain a searched audio file, when the at least one group of dynamic parameters is the physiological parameter, and determining the searched audio file to be played next;
selecting an audio file matching the physiological parameter from the server and obtaining a selected audio file, when none of the plurality of audio files in the current music playlist matches the physiological parameter; and
adding the selected audio file to the current music playlist.

33. The non-transitory storage medium according to claim 30, wherein the method further comprises:
determining a remaining time length by comparing the current parameters of sport with preset targets of sport, when the received dynamic parameters are current parameters of sport of the terminal device;
calculating time length difference between total time length of audio files in the current music playlist that are not played yet and the remaining time length to obtain a calculated time length difference, when the total time length of the audio files in the current music playlist that are not played yet is less than the remaining time length;
selecting one or more audio files whose time lengths match the calculated time length difference from audio files corresponding to the received state parameters or from audio files corresponding to the received preferred parameters stored in the server, and obtaining one or more selected audio files; and
adding the one or more selected audio files to the current music playlist.
